(19) United States
(12) Patent Application Publication
(10) Pub. No.: US 2007/0241931 A1
(43) Pub. Date: Oct. 18, 2007

(54) Wireless automation systems and processes for wells

(75) Inventors: Larry J. Compton, Castle Rock, CO (US); Lucian Novac, Elizabeth, CO (US); Cham Ocondi, Aurora, CO (US); Mark Ocondi, Aurora, CO (US)

Correspondence Address: GREENLEE WINNER AND SULLIVAN P C, 4875 PEARL EAST CIRCLE, SUITE 200, BOULDER, CO, 80301, US

(73) Assignee: VECO Gas Technology, Inc.

(21) Appl. No.: 11/726,479

(22) Filed: Mar. 21, 2007

Related U.S. Application Data
(63) Continuation-in-part of application No. 10/536,676, filed on May 27, 2005.
(60) Provisional application No. 60/773,161, filed on Mar. 21, 2006.

(51) Int. Cl. G08C 19/00

(52) U.S. Cl. 340/870.11

(57) ABSTRACT

This system connects groups of end-devices at two or more automated oil or gas production wellheads or groups of end-devices at two or more associated wellhead facilities so that such associated end devices may be wirelessly monitored and measured during wellhead production, and then wirelessly controlled by one or more master remote terminal/telemetry unit MRTU. Each MRTU is in turn in communication with and controlled by a host computer system. Such measurement and control of the end devices is accomplished through slave remote terminal/telemetry units SRTUs which are connected to and capable of communications with associated end-devices. Each SRTU is in turn connected to one or more local area network LAN communication system, each of which LAN is in turn connected, by hard wire or wirelessly, to a wide area network WAN transmitter. Each WAN is in wireless communication with a host computer.

### RELATED APPLICATIONS

The present application claims the benefit under title 35 United States Code, Section ii 9(e) of U.S. provisional application No. 60/773,161 filed Mar. 21, 2006 entitled “Multiple well wireless automation system”; and is a continuation in part of Ocondi, M. U.S. patent application Ser. No. 10/536,676, filed May 27, 2005, based on PCT/US2003/034812 application filed Oct. 30, 2003.

### BACKGROUND OF THE INVENTION

1. Field of the Invention

The present invention relates to a system in which one or more master remote terminal/telemetry unit (MRTU) is wirelessly connected to a central host system, for example a computing system, using wireless multi-cast networking communication to create a wide area network (WAN). The wireless multi-cast networking communication system allows an operator to monitor and control two or more automated wells and/or associated well facilities from virtually any location.

2. Background of the Related Art

State-of-the-art modern hydrocarbon (gas or oil) production wellheads are automated using systems commonly referred to as supervisory control and data acquisition (SCADA) systems as taught by Ocondi, C. U.S. Pat. No. 5,983,164. Such SCADA systems are each designed to calculate gas and fluid production from a production wellhead, as well as monitor production trends and control with passive and active end-devices. As is well known in the art, wellhead end-devices include tubing and casing pressure transducers to transmit their readings, multi-variable transducers, position switches, motorized choke valves, and so on at each individual well site. These wellhead end-devices are currently typically connected to a remote terminal/telemetry unit (RTU) with underground wiring. It is also common practice to automate associated production facilities such as separator/dehydration units, production meter-runs, and tank batteries by connecting end devices at these facilities to the wellhead RTU with underground wiring.

The wellhead and its associated facilities are typically separated by some distance. It is not uncommon to find wellhead systems in which tubing and casing pressure transducers, choke controllers, plunger arrival switches, and other end-devices installed more than several hundred feet away from the separation/dehydration equipment, the meter-run end-devices at which gas and fluid production are measured, and the tank battery end-devices. Hydrocarbon measurement is normally accomplished using electronic transducers that measure static and differential pressures and temperature across the orifice meter usually installed downstream from the separator/dehydration facilities. Fluid flow results are most often calculated by a microprocessor associated with the RTU in accordance with the requirements of AGA-3 (American Gas Association Report #3).

Typically separation/dehydration vessels and storage tanks are installed at least fifty feet away from a wellhead in order to allow wire-line equipment and work-over rigs easy access to the wellhead. In addition, on occasion surface restrictions for wells drilled in farming or agricultural areas may require that separation/dehydration facilities as well as the tank batteries be located hundreds or even thousands of feet away from a wellhead.

In addition, systems that allow well operators to monitor, control, and optimize production of oil or gas from wellheads from virtually anywhere using field wireless local area network (LAN) and wide area network (WAN) communication systems or multicast wireless network systems are taught by Ocondi, M. U.S. patent application Ser. No. 10/536,676, filed May 27, 2005.

It is noted that conventional RTUs referred to above are designed to automate only one well or one associated well facility as there is no economical reason to develop conventional RTU software to handle multiple wells or multiple associated well facilities because the cost of installing underground wiring to connect multiple wells and/or associated well facilities is significantly greater than installing an individual RTU at each well site and at each associated well facility.

It is therefore seen that there is an economic justification to wirelessly link two or more wellheads and/or two or more associated well facilities by using a slave remote telemetry unit (SRTU) and/or a MRTU in lieu of wires or cables. The cost of the SRTU and the MRTU for communication using a field LAN system that wirelessly links two or more end-devices to the MRTU can easily off set the cost of a hardwire cable installation of say thirty feet or less. Also, ditching and trenching operations around wellhead facilities is hazardous. It has been generally recognized in the gas and oil production industry that cables that are cut as a result of facility repair is a major cause of automation systems downtime.

In addition it is seen that developing software to handle multiple wells and end devices at multiple associated well facilities would in fact be economically advantageous.

### SUMMARY OF THE INVENTION

It is thus an object of the present invention to provide a system that is specifically designed to wirelessly connect groups of end-devices at two or more oil or gas production wellheads or groups of end-devices at two or more associated well facilities, and mixtures thereof so that the associated end devices may be wirelessly monitored and measured during wellhead production, and then wirelessly controlled by one or more master remote terminal/telemetry unit MRTUs, and in turn wirelessly controlled by a master host computer system according to the teaching of the present invention. Such measurement and control is accomplished through slave remote telemetry units SRTUs associated with the end devices. This is accomplished by using, in lieu of hardwire or cable, one or more wireless sub-network LAN communication systems to connect the end devices of two or more well systems with the MRTU through the SRTUs.

That is, rather than using one conventional RTU to monitor, measure, and control one well or end devices at one associated well facility, a MRTU in wireless communication with multiple SRTUs that are operatively attached to end-devices installed at two or more wells or two or more associated well facilities, or mixture thereof, is provided by the present invention to operate as multiple state-of-the-art RTUs. Each MRTU is configurable with two or more RTUs of the present invention. As taught herein, individual wells or associated well facilities are given unique memory addresses and that memory is partitioned to recognize and store trending, measurement, and control algorithms from each end device group installed at each of two or more well sites or at each of two or more associated well facilities. The MRTU is programmed to recognize whether the end-devices are connected directly to its input/output (I/O) through hard-wired connection or whether they are connected wirelessly to a SRTU. The MRTU is programmed to sort out the end-device or devices attached to a particular well system of the two or more well systems or to a particular system of two or more associated well facilities. Each MRTU can be programmed to perform the task of multiple on-site electronic flow measurement EFM computers complete with high-resolution audit-trail as taught by Ocondi, C. U.S. Pat. No. 5,983,164. Control algorithms of the MRTU are customized to individual wells or to individual associated well facilities to affect production monitoring, control and optimization of each well system or associated well facility by wireless linkage. The communication program for the MRTU will appear to the master host, for example, a personal computer, or other state-of-the-art computing system, as if there is an individual conventional RTU installed at each of the multiple well or associated well facility sites.

It is thus seen that in the present invention the long and costly cable or hardwire wire, along with the costly trenching to put it in place that traditionally connects field end devices are replaced with a field wireless LAN data radio and the SRTU directly attached to multiple end-devices at multiple wells and/or multiple associated well facilities. This not only solves the installation cost problems associated with the topology and remoteness of the wellheads and end-devices installed at various parts of the wells production facility, it also adds or distributes the intelligence and the data of the systems to the discrete MRTUs and host device so that captured data integrity and functional reliability of automated well control and production optimization are significantly enhanced. More importantly, the present invention wirelessly expands the input/output (I/O) capability of the MRTU significantly beyond its on-board I/O counts available from a single well automation system.

Taking advantage of the teaching of the present invention that a MRTU can be used to wirelessly link SRTUs attached to end-devices associated with two or more wells and/or end devices attached to two or more associated well facilities, the present invention also teaches methods and processes of configuring a MRTU to operate with multiple RTUs. The system of the present invention and the process of using it allow the MRTU to automate two or more well systems and/or two or more associated well facilities. The MRTU in wireless connection through the field LAN with multiple SRTUs installed at two or more wellheads or two or more associated well facilities is able to operate as if it provided multiple on-site electronic flow measurements (EFMs) in compliance with API 21.1 and BLMs NTL 2004-01. The invention of the present invention also operates as multiple automated well or end device control systems to affect production optimization and provides detailed historical data capturing and event logging of operating alarm conditions as taught by Ocondi, C. U.S. Pat. No. 5,983,164.

Finally, the present invention also has the ability to retrofit state-of-the-art existing RTUs, Remote I/O units, EFMs, and programmable logic controllers (PLCs) to economically affect wireless measurement and production optimization.

The present invention can also be applied to retrofit with state-of-the-art, or conventional third-party supplied RTUs with EFM and control capability that require upgrade. A MRTU can be associated with two or more wells and/or two or more associated well facilities in which each well or associated well facility has an existing RTU, and each RTU is in turn equipped with a data radio to wirelessly connect it to the MRTU. In such a retrofit configuration each RTU is programmed to operate as a passive device or a wireless remote I/O device. The retrofit system based on the master remote telemetry unit MRTU will provide high resolution trending data, an EFM system with on-site and off-site capability, and a controller with customized control algorithms.

As used herein, and as set forth in context in the attached figures and in the detailed description below, the MRTU is a computer with software and hardware that records and trends various analog data and controls remote electronic devices measuring and controlling the production of oil and gas fields. Such devices include, for example, those used for reading pressure and flow volumes in oil and gas wells and fields. Other electronic devices are used to open and close valves in oil and gas wells and fields. The MRTU, also records device information, which, in the practice of the present invention, are transmitted and received data to and from the SRTU, using wireless spread spectrum, (SS) data radio communication technology. The MRTU, with the ability to store multiple well and/or associated well facility data, is also equipped with another WAN data radio that is in communication with a master host and other remote hosts, for example, a personal computer, PC or other state-of-the-art computing system, systems that allow the users to control, monitor and optimize production from virtually anywhere as taught by Ocondi, M. U.S. patent application Ser. No. 10/536,676, filed May 27, 2005.

In addition to wireless SS data radios, it should be noted that for purposes of the present invention WAN communication among remote hosts and MRTUs may use other state-of-the-art known conventional wireless technologies and future wireless communication technologies. Such communication technologies include satellite technology, cell phone technology, licensed radio technology and others. However, it is currently found that SS data radio is the preferred wireless communication system since it is most cost effective and provides better overall performance in terms of reliability and flexibility.

As also used herein and detailed below, SRTUs, are also computers with software and hardware capable of reading the end-devices, flow calculation and controlling external end-devices such as pressure transducers, plunger arrival switches, motorized choke valves, tank level transducers, etc. The data stored in the SRTU, can be uploaded and downloaded from other SRTUs and MRTUs. Data transferred wirelessly among the MRTUs, and SRTUs is done through a field LAN.

In addition, as used herein, the term “end device” includes well system measuring and controlling devices such as tubing pressure transducers, casing pressure transducers, control valve, valve position switches, and plunger arrival switches. The term “end device” also includes meter-run transducers and tank battery system transducers, as well as any current or future measuring and controlling devices used with wells or associated well facilities now or in the future. Such end devices and related groups of end devices are all included in the term “end device” as used herein.

As further detailed below, the data transferred wirelessly among the MRTUs and the master host and the computer host is through a field WAN, or multicast wireless network system as taught by Ocondi, M. U.S. patent application Ser. No. 10/536,676, filed May 27, 2005, or other state-of-the-art computing systems.

These and other teachings of the present invention will become apparent to those skilled in the art from the following detailed description, showing the contemplated novel construction, combination, and elements as herein described, and more particularly defined by the appended claims, it being understood that changes in the precise embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments of the present invention according to the best modes presently devised for the practical application of the principles thereof, and in which:

FIG. 1 illustrates two types of wireless networking systems, according to the teaching of the present invention, that each serve to provide a user with a field wireless wide area network WAN and a field wireless local area network LAN to provide system users access from multiple end devices and well systems or associated well facilities to a master remote terminal/telemetry unit MRTU to monitor operating data and allow wireless remote control of such end devices and well systems and associated well facilities; and

FIGS. 2A and 2B show a flow-chart of the master remote terminal/telemetry unit MRTU software allowing wireless communication with the slave remote telemetry unit SRTU and/or third party legacy RTUs and allows the slave remote telemetry unit SRTU to function as a state-of-the-art multiple remote terminal/telemetry unit RTU.

### DETAILED DESCRIPTION OF THE PREFERRED EMBODIMENTS

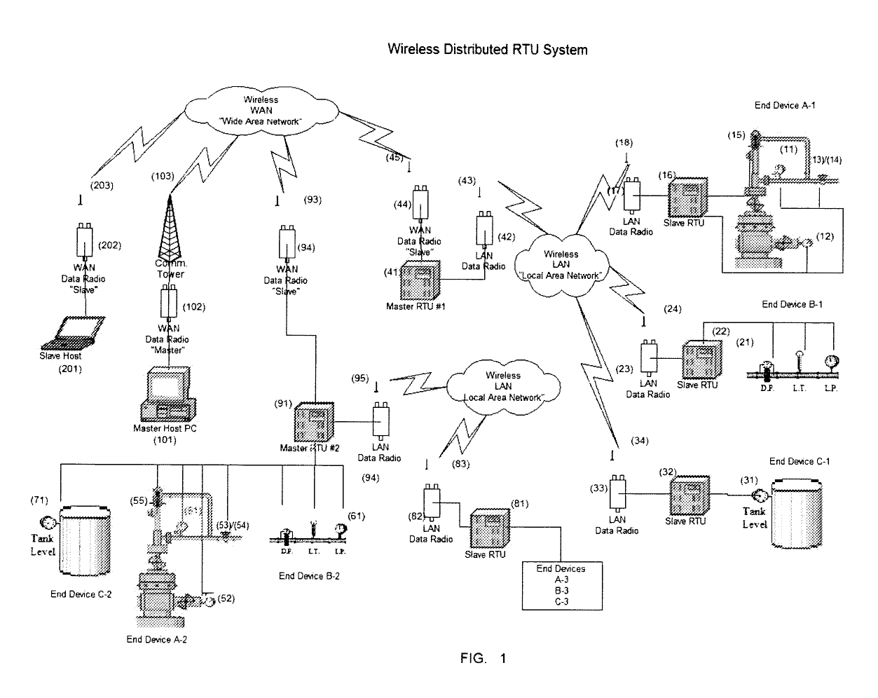

Referring to FIG. 1, a group of related end devices are shown on the right side illustrating a representative physical layout of various groups of end-devices that are commonly installed at gas or oil wellhead. These include, for example wellhead system End Device A-1, meter-run End-Device B-1, and Tank Battery system End-Device C-1. Note, as explained below in view of the teaching of the present invention, the physical proximity of the three related groups of end devices is not critical.

Well head system End Device A includes state-of the-art measuring and controlling devices such as tubing pressure transducer (11), casing pressure transducer (12), control valve (13), valve position switch (14), and plunger arrival switch (15). These are all hardwire connected in the vicinity of the wellhead to slave remote telemetry unit SRTU (16). SRTU (16) is in turn hardwire connected to radio (17) including antenna (18).

Referring again to FIG. 1, meter-run End-Device B-1, multivariable transducer (21) is hardwired to SRTU, B1 (22). SRTU B1 (22). SRTU B1 (22) is in turn hardwire connected to data radio (23) and antenna (24). In this embodiment to FIG. 1, tank level transducer (31) is directly wired to SRTU, C-1 (32). SRTU C-1 (32) is in turn hardwire connected to data radio (33) and antenna (34).

In this modified system tank level transducer (71), tubing pressure transducer (51), casing pressure transducer (52), control valve (53), valve position switches (54), and flow transducer (61) of wellhead End device A-2 are all directly hardwire connected to master remote telemetry unit MRTU #2 (91). unit MRTU #2 (91) is directly connected to data radio (94) and antenna (95). MRTU #2 (91) is in wireless communication with SRTU, (81) via data radio (82) and antenna (83), which is part of the field wireless LAN. Referring to FIG. 1, a group of related end devices are shown on the left. These include, for example wellhead system End Device A-1, meter-run End-Device B-1.

Thus, this group of related end devices shows connectivity of end-devices-group A-1, B-1, and C-1 of what is arbitrarily designated as well system #1 directly wired to SRTUs (16), (22) and (32) operatively attached to respective end-device groups A-1, B-1, and C-1. It also shows the three field wireless LAN data radios (1), (22) and (33) and their respective antennas of well system #1 arrayed for wireless communication to MRTU #1 and the wireless connection of MRTU #1 to the field wireless WAN with the master host (101) for example a personal computer, PC (101), or other state-of-the-art computing systems such as slave remote host system (201), all as set forth in greater detail below.

Note that MRTU #1 seen in the upper center of FIG. 1 is shown to be designed to receive data wirelessly from a group of SRTUs (16), (22) and (32) from well system #1 only. It should be noted however that MRTU #1 is capable of receiving data wirelessly from SRTUs associated with two or more wells and/or associated well facilities, as illustrated and as set forth in greater detail below.

Referring once again to FIG. 1, a second group of related end devices are shown on the lower left. These include, for example, wellhead system #2 including End Device A-2, meter-run End-Device system B-2, and Tank Battery system End-Device C-2. In this system #2 tank level transducer (71), tubing pressure transducer (51), casing pressure transducer (52), control valve (53), valve position switch (54), and flow transducer (61) of wellhead End device A-2 are all directly hardwire connected to MRTU #2 (91). This modified MRTU #2 (91) is directly connected to data radio (94) and associated antenna (95). However, in this embodiment MRTU #2 (91) is in wireless communication with SRTU, (81) via data radio (82) and antenna 83 which is part of the field wireless LAN as shown, and as set forth in greater detail below.

As further shown in FIG. 1 at the lower center, a group of related end devices A-3, B-3, C-3, for example associated with a third wellhead system, all not shown, are identified. A SRTU (81) is hardwire attached to end-devices A-3, B-3, C-3. In practice, and as illustrated by the system of well #1, end devices A-3, B-3, and C-3 of well #2 Are operatively attached or hard wired to individual SRTUs. This portion of the drawing has been simplified to show a single SRTU and other end devices of well #3 in order to illustrate that a single MRTU is capable of monitoring and controlling two or more wells.

In this embodiment SRTU (81) is in turn directly connected to data radio (82) and antenna (83) which is also part of the field wireless LAN, as shown, and as set forth in greater detail below.

It should be noted that additional wells and end-devices can also be wirelessly linked to MRTU #2 (91) via the SRTU not shown in the drawing so long as they are within radio range of a shared field wireless LAN.

In the approximate center of FIG. 1, MRTU #1 (41) is connected to data radio (44) having antenna (45). To the left of that is illustrated MRTU #2 (91) wirelessly connected to data radio (94) having antenna (93).

Now at the left center of FIG. 1, there is illustrated a master host, for example, a personal computer, PC (101), or other current or future state-of-the-art computing system. Master host (101) is operatively connected to data radio (102), which is in turn operatively connected to radio tower (103) to the field wireless WAN, or a portion of a field wireless WAN. Also at the left center of FIG. 1, there is illustrated a slave host, for example, a notebook computer (201), or other current or future state-of-the-art computing system. Slave host (201) is operatively connected to slave data radio (202) having an antenna (203) which forms a portion of a field wireless WAN, radio tower (103) and antenna (202) are wirelessly linked through the field wireless WAN, to wirelessly receive data signals from multiple data radio systems from two or more end devices, in this illustration from LAN data radio (17) and antenna (18), LAN data radio (23) and antenna (24), LAN data radio (33) and antenna (34), LAN data radio (82) and antenna (83), and LAN data radio (94) and antenna (95), and also via WAN data radio (94) and antenna (93). The details and operations of such wireless LAN and WAN communication systems are taught in greater detail by Ocondi, M. U.S. patent application Ser. No. 10/536,676, filed May 27, 2005, the details of which are incorporated herein by reference.

For purposes of illustration, remote host computer (201) has been shown as a notebook computer to illustrate a practical portable field host system. Notebook host computer (201) operates in all other ways in the same manner as host computer (101). Host computer (201) is not required for host computer (101) to operate, nor is host computer (101) required for host computer (201) to operate. Furthermore, although not shown, more than two host computers may be associated with the system of the present invention, and so long as one host computer is wirelessly operationally involved, the system of the present invention can function.

Throughout the system shown, SRTUs in communication with the Tank battery and connected to end-devices will scan and store detailed raw data (configurable down to one-second or less) of Tank level data of multiple tanks (in this case, condensate and salt-water tanks). It will calculate the amount of liquid produced through Tank level increment and store the results. It will transmit alarm messages when a preset level is detected to the SRTU to control and prevent spillage and transmit to the host computer (101), or other state-of-the-art computing systems, via MRTU, to affect Tank level management by providing a timely liquid hauling schedule.

The MRTU, in wireless communication with the SRTU, s in the field wireless LANs, will store trending and event log data and organize the data on a per well basis, in order that host computer (101), or other state-of-the-art computing systems can retrieve, store, and display, the well data for analysis to affect production optimization.

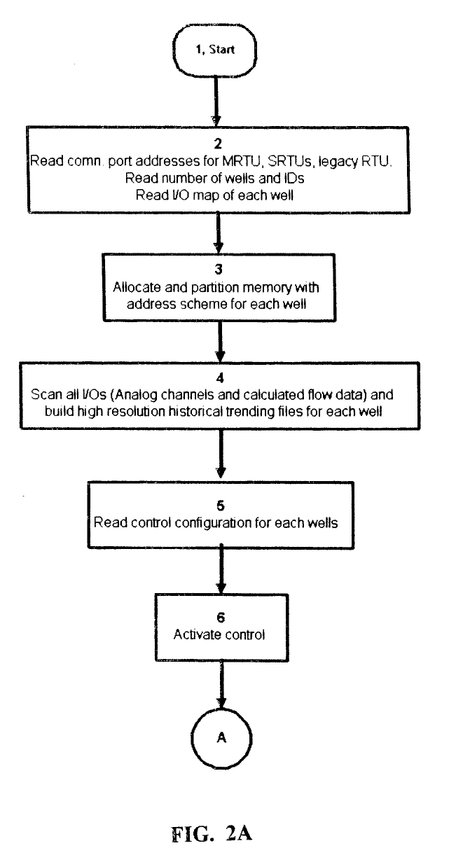

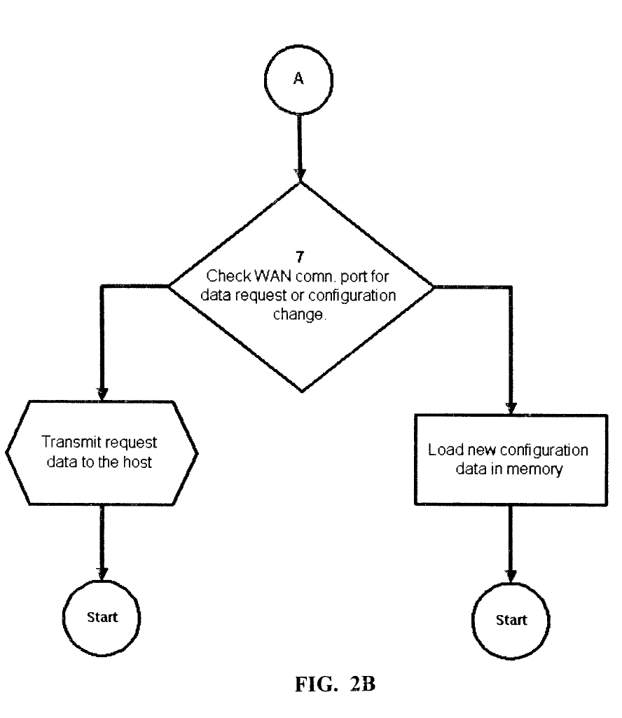

FIGS. 2A and 2B represent a single flow-chart of the MRTU software allowing and controlling wireless communication with the SRTU or third party legacy RTU and incorporates all I/Os of the SRTU or legacy RTU to function as its own built-in I/O. The end result is that the MRTU's I/O count can be expanded to the limit of the MRTU memory by simply adding SRTUs.

In the above preferred embodiment, the MRTU's I/O is wirelessly connected to end-devices of multiple wells, which requires software to monitor and control the end-devices installed at each well. At the same time it must be able to communicate to the master and the remote host systems to transfer trending data as well as control and calibration configurations among the host systems and the MRTU. To affect the data transfer, each MRTU must be able to sort out data associated to each well. The following describes the functionalities of the steps of FIGS. 2A and 2B flow-chart software:
Step 1: the processor in the MRTU starts execution of the application software either when the power is turned “on” or it is reset by software or the hardware.
Step 2: the processor reads the pre-configured data, defining the number of wells or end devices it is assigned to monitor, measure, and control. It will be prompted with the WAN and LAN networks addressing communication scheme to affect communication with the host systems as well as all the SRTUs or the other legacy RTUs connected to the end-devices installed at each well or well's associated facility. It will be prompted to sort and recognize I/O devices designated to each well or end device.
Step 3: memory is allocated and assigned to each well or end device to cover all the trending files for 35 days and event logs all the configuration changes.
Step 4: read all I/Os to build high-resolution trending files configurable to one-second resolution.
Step 5: read in control configuration and strategy for all wells or end devices assigned.
Step 6: activate control per the above Step 5 strategy sequentially.
Step 7: check WAN communication port for host's data request or configuration changes of new control, and calibration, or additional well I/O maps.

After responding to either transmitting the requested data or storing the downloaded configuration data from the host the processor repeats the execution from “Start” of Step 1.

It is therefore seen that a system for wirelessly linking end devices on two or more wellheads and/or two or more associated well facilities using a SRTU and/or a MRTU in lieu of wires or cables has been taught, and that it can easily offset the cost of a hardwire cable installation, as well as the cost, complications and hazards of ditching and trenching operations around wellhead facilities. In addition the present invention provides a system and process that is specifically designed to wirelessly connect groups of end-devices associated with two or more oil or gas production wellheads so that the associated end devices may be wirelessly monitored and measured during wellhead production, and then wirelessly controlled by a single MRTU, and in turn wirelessly controlled by a master host computer system, according to the teaching of the present invention. It is further taught how such measurement and control is accomplished wirelessly through SRTUs associated with the end devices by using, in lieu of hardwire or cable, one or more wireless sub-network field wireless LAN communication systems to connect the end devices of two or more wellheads and/or two or more associated well facilities with a MRTU through SRTUs. Furthermore a software flow chart for handling end devices on multiple wells and/or multiple associated well facilities has been shown.

While the invention has been particularly shown, described and illustrated in detail with reference to preferred embodiments and modifications thereof, it should be understood by those skilled in the art that the foregoing modifications are exemplary only, and that equivalent changes in form and detail may be made therein without departing from the true spirit and scope of the invention as claimed, except as precluded by the prior art.

What we claim is:

1. Systems for measuring and controlling the production of hydrocarbons at two or more associated automated wellheads, each automated wellhead having two or more (groups of) end-devices, each end device (group) being connected to remote telemetry unit RTU, and each RTU being connected to one or more local area network LAN communication system, the improvement including:
each remote telemetry unit RTU including computing hardware means and associated software means, each said RTU having means for two way communications with one or more associated end device;
one or more master remote terminal/telemetry unit MRTU, in which each said MRTU includes means for computing and associated software, and also including means for two way communications by hard wire connection or wirelessly with one or more LAN;
one or more wide area network WAN communication system, wherein each WAN is in turn connected by hard wire or wirelessly to at least one said MRTU; and
at least one host computer system; whereby each MRTU is in two way wireless communication with and controlled by a said host computer system; and whereby further such associated end devices may be monitored and measured during production by the automated wellhead, and then controlled from virtually any location from one or more host computer system.

2. The measuring and controlling systems of claim 1, wherein at least one RTU is a slave remote telemetry unit SRTU that is in two way communication with at least one associated end-device, and said SRTU includes means for measuring and controlling said at least one end devices.

3. The measuring and controlling systems of claim 1, wherein said MRTU and SRTU means for computing and associated software capable of reading associated end-devices, record data produced by each said end device, and trending various analog data and then controlling such associated end devices.

4. The measuring and controlling systems of claim 3, wherein said data read and recorded and controlled by said SRTU includes flow, flow calculation, control of end-devices including pressure transducers, plunger arrival switches, motorized choke valves, and Tank level transducers, and wherein such system includes means for uploading and downloading data stored in the SRTU any other from other SRTU and MRTU in the control system through a LAN.

5. The measuring and controlling systems of claim 1, wherein two or more SRTUs are in communication with one MRTU in a LAN communication system.

6. The measuring and controlling systems claim 5 wherein said SRTUs are designed to operate as a wireless extension of the MRTU with passive I/O (Input/Output) functionality.

7. The measuring and controlling systems of claim 5 wherein each said SRTUs is designed to acts as a stand-alone programmable controller and to monitor and control end-devices directly connected to said SRTU.

8. The measuring and controlling systems claim 5 wherein each said SRTUs is designed to read and store analog data from transducers includes in said end devices and to event log the status of valve position changes and plunger arrival records.

9. The measuring and controlling systems of claim 5 wherein each said SRTUs is designed to wirelessly upload control algorithms from a MRTU and exercise control of the productivity of an associated automated well to affect production optimization.

10. The measuring and controlling systems claim 5 wherein each said SRTUs is designed to wirelessly read and store analog data from transducers that are connected to other SRTUs in the LAN network.

11. The measuring and controlling systems of claim 5 wherein each said SRTUs is designed to store historical trending data and to transfer such data wirelessly between said SRTUs and a MRTU.

12. The measuring and controlling systems claim 5 wherein each said MRTUs is designed to coordinate the control of each associated automated well through two or more associated SRTUs connected together through a wireless system.

13. The system of claim 1 wherein each end device has a unique address and said MRTU is designed to operate as multiple RTUs, including individual automated well communication to each unique devices address and communication protocols which allow said host computer to monitor alarm condition, trending data transfer, and control strategy downloading from Tank batteries.

14. The system of claim 1 in which each said MRTU is designed to communicate with a host computer and with other MRTUs in the WAN network.

15. The system of claim 14 said communication of said MRTUs with a host computer and with other MRTUs in the WAN network is wireless.
